(19) United States
(12) Patent Application Publication
(10) Pub. No.: US 2002/0083601 A1
(43) Pub. Date: Jul. 4, 2002

(54) Compass cutter

(76) Inventor: Chen Shan Ming, Taichung (TW)

Correspondence Address: Chen Shan Ming, P. O. BOX 453, TAICHUNG, TW

(21) Appl. No.: 09/750,358

(22) Filed: Dec. 29, 2000

(51) Int. Cl. B43L 9/04

(52) U.S. Cl. 33/27.03; 33/27.032

(57) ABSTRACT

A compass cutter comprises a main body fastened with an extension rod which is connected with a slidable seat slidable along the extension rod. The main body is further provided with a locating block, a protective cover, a blade, a fixation block, and an insertion pin. The slidable seat is provided with a locating block, a connection rod, a locating pin, and a shield. The compass cutter can be expanded, thanks to the extension rod. The locating pin and the blade are shield by the shield to protect the user of the compass cutter.

### BACKGROUND OF THE INVENTION

1. Field of the Invention

The present invention relates generally to a hand tool, and more particularly to a compass cutter.

2. Description of Related Art

As shown in FIG. 1, a compass cutter of the prior art comprises a main body 10, a slidable seat 11, a connection rod 12, a blade 13, and a locating pin 14. The main body 10 has a length which is so limited as to hinder the application of the prior art compass cutter. In addition, the connection rod 12 can not be folded to make the compass cutter compact to facilitate the carrying of the cutter. Furthermore, the blade 13 and the locating pin 14 are so exposed that they are hazardous to safety of a user of the compass cutter.

### BRIEF SUMMARY OF THE INVENTION

The primary objective of the present invention is to provide a compass cutter which is free of the drawbacks of the prior art compass cutter described above.

The compass cutter of the present invention comprises a main body, a slidable seat, an extension rod, a connection rod, and a blade. The extension rod is disposed between the main body and the slidable seat. The blade is secured in place by a fixation block. The connection rod is pivotally fastened with the slidable seat.

The features and the advantages of the present invention will be more readily understood upon a thoughtful deliberation of the following detailed description of the present invention with reference to the accompanying drawings.

### BRIEF DESCRIPTION OF THE SEVERAL VIEWS OF THE DRAWINGS

FIG. 1 shows a perspective view of a compass cutter of the prior art.

FIG. 2 shows a perspective view of a compass cutter of the present invention.

FIG. 3 shows an exploded view of the compass cutter of the present invention.

FIG. 4 shows a schematic view of the present invention in use.

FIG. 5 shows a schematic view of the present invention in the folding state.

FIG. 6 shows a schematic view of the adjusting of the blade of the present invention.

FIG. 7 shows a schematic view of the locating of the blade of the present invention.

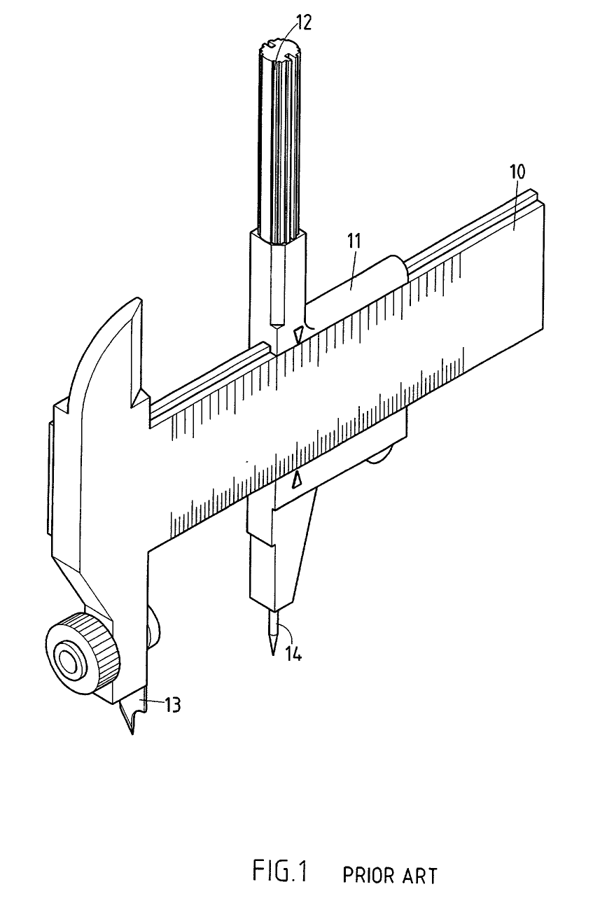

### DETAILED DESCRIPTION OF THE INVENTION

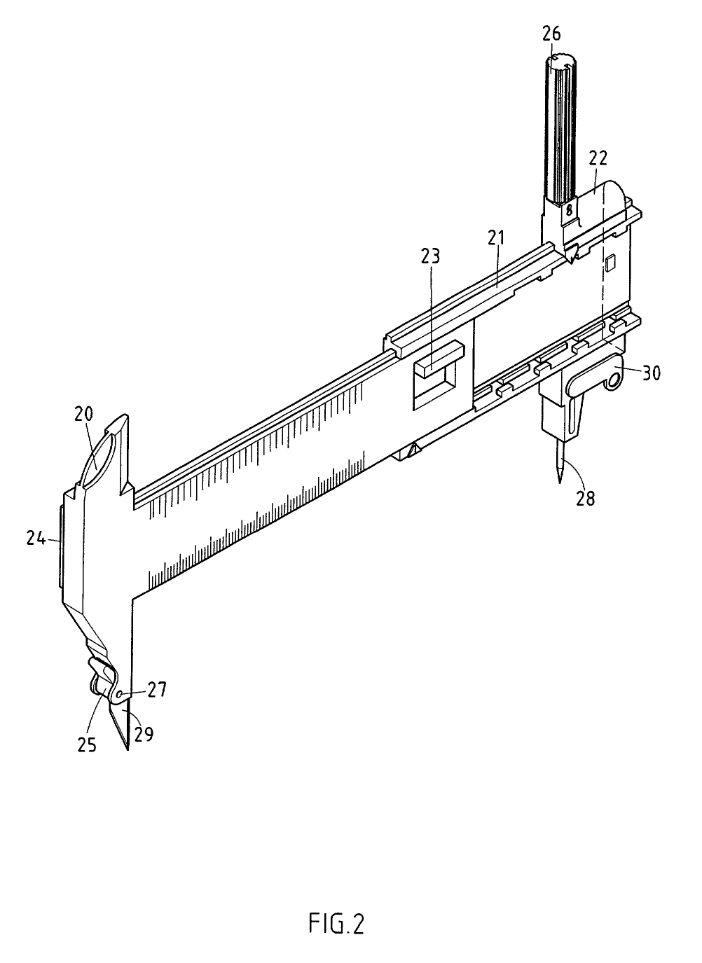

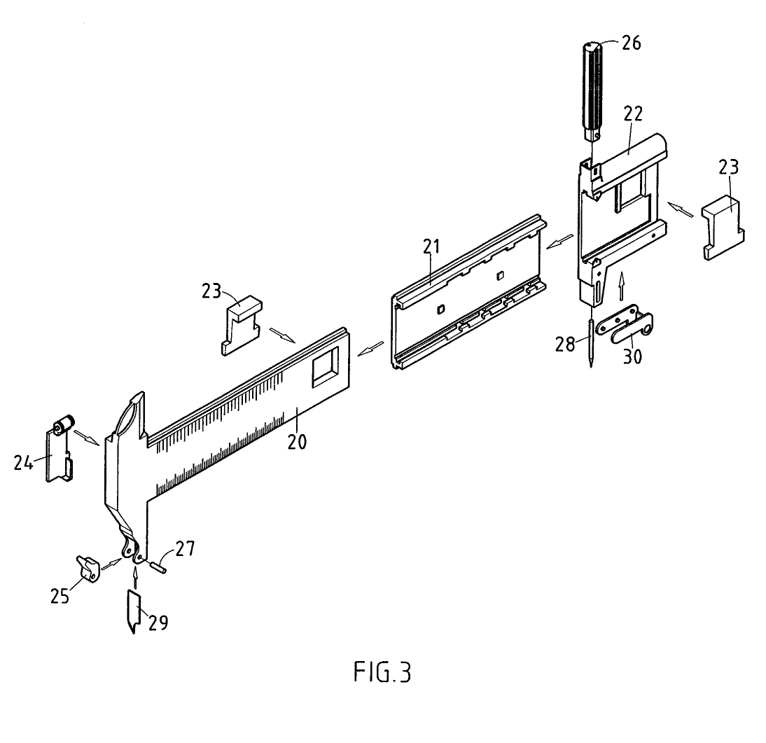

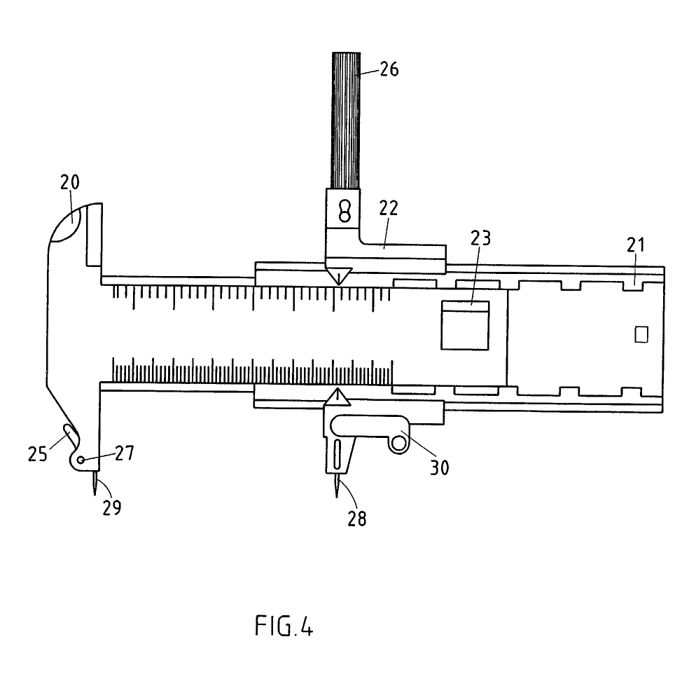

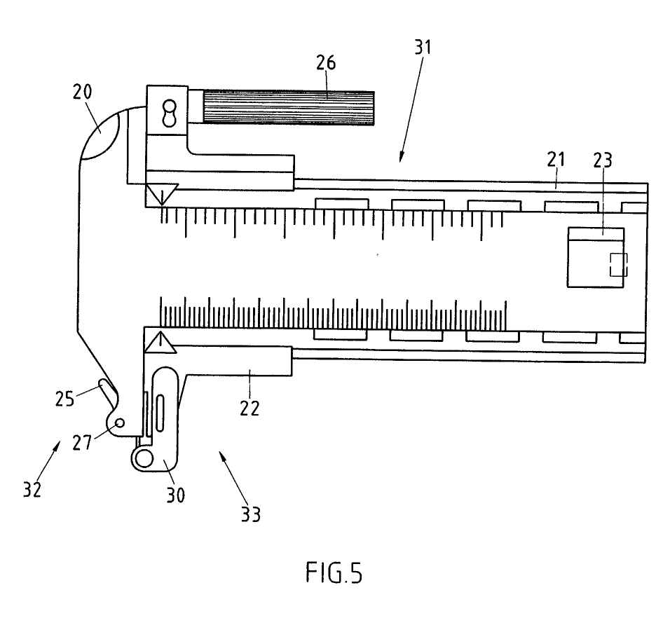

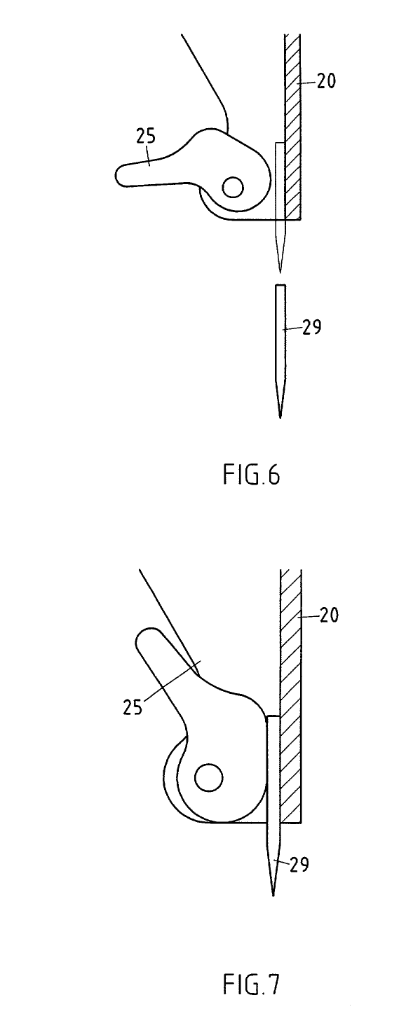

As shown in FIGS. 2-7, a compass cutter 31 embodied in the present invention comprises a main body 20, an extension rod 21, and a slidable seat 22.

The main body 20 has an appropriate length, a stop end which is provided with a cutter member 32, and other end which is provided with a guide rail. The main body 20 is further provided with a fastening hole for fastening a locating block 23. The main body has a scale, and a receiving space for keeping the blade 29, the locating pin 28, etc. The receiving space is provided with a cover 24.

The extension rod 21 has a guide slot and a guide rail, two stop blocks 34 for confining the maximum sliding distances of the extension rod 21 and the slidable seat 22.

The slidable seat 22 is provided with a connection rod 26 pivoted therewith such that the connection rod 26 can be folded. The slidable seat 22 is provided in the bottom with a locating pin 28 and a safety member 33 having a projection 301. The slidable seat 22 is provided in two sides of the lower edge with a retaining slot 221 for locating the projection 301 of the safety member 33. The slidable seat 22 is provided with a locating block 23 in contact with the extension rod 21. The locating block 23 has an inclination.

The cutter member 32 of the present invention has a fixation block 25 for fixing the blade 29 at the stop end of the main body 20 in conjunction with an insertion pin 29. The fixation block 25 can be turned on the insertion pin 29 for regulating the locating point of the blade 29.

The safety member 33 of the present invention has a protective cover 30 for covering the locating pin 28 and the blade 29. The protective cover 30 is pivoted with the bottom of the slidable seat 22. The safety member 33 further has the projection 301 for locating the compass cutter 31 in storage.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following appended claims.

I claim:

1. A compass cutter comprising
a main body of a length and having a top end which is provided with a cutter member, said main body further having other end opposite to said stop end and provided with a guide rail, said main body further provided with a fastening hole for fastening a locating block, a scale, and a receiving space having a cover;
an extension rod having a guide slot, a guide rail, two stop blocks for confining a maximum sliding distance of said extension rod; and
a slidable seat provided with a connection rod pivoted therewith such that said connection rod can be folded, said slidable seat further provided in a bottom with a locating pin and a safety member having a projection, said slidable seat further provided with a retaining slot for locating said projection of said safety member.

2. The compass cutter as defined in claim 1, wherein said cutter member has a fixation block for fixing a blade at said stop end of said main body in conjunction with an insertion pin on which said fixation block is turned for controlling the locating point of said blade.

3. The compass cutter as defined in claim 1, wherein said safety member has a protective cover for shielding said locating pin and said blade whereby said protective cover is pivoted with the bottom of said slidable seat.
